(19) United States
(12) Patent Application Publication
(10) Pub. No.: US 2018/0047096 A1
(43) Pub. Date: Feb. 15, 2018

(54) GROUP BIDDING SYSTEM AND METHOD

(71) Applicant: James Xu, Chicago, IL (US)

(72) Inventor: James Xu, Chicago, IL (US)

(21) Appl. No.: 15/232,725

(22) Filed: Aug. 9, 2016

(51) Int. Cl. G06Q 30/08; G06Q 20/10

(52) U.S. Cl. CPC G06Q 30/08; G06Q 20/102

(57) ABSTRACT

This invention concerns a group bidding system and method capable of providing buyer motivation to make purchase offers of multiple products and services and aggregating said purchase offers of multiple products and services from one buyer or multiple buyers and bidding such purchase offers to one seller or multiple sellers of said multiple products or services, comprising a central control system, a database, a buyer interface, a seller interface, a credit verification interface, and a payment interface.

### BACKGROUND OF THE INVENTION

### Field of the Invention

The present invention relates to a group bidding system and method. More specifically, my invention is primarily relates to a group bidding system and method to gather purchase offers for multiple products from one or multiple potential buyers, aggregate the prices of such purchase offers, and communicate the aggregated prices and volume of each of such multiple products to seller or sellers of such multiple products. The current invention provides buyers with motivation to make purchase offers at their earliest convenience rather than wait until a later time. The current invention provides buyers at an earlier bidding period with the same bidding price at a later bidding period, if the price at a later bidding period is better than that at an earlier bidding period. The current invention enables one or multiple buyers with different expectations in prices for multiple products to aggregate their demands together, and communicate such total prices and volumes for multiple products to the seller or sellers of the multiple products. One buyer who offers a lower than seller's willing-to-sell price for the product will be able to purchase the product, because the other buyer who offers a higher than seller's willing-to-sell price for the same product or other products. The current invention enables a group of buyers to make purchase offers for one or multiple products without pricing information, but enables multiple sellers to compete and provide such group of buyers the best price possible. The current invention enables seller to be able to sell product at maximum number to a certain group of buyers at an average price equal or above seller's willing-to-sell price. The current invention also enables buyers to group together their demand and total prices for multiple products and make a bid to the seller of such multiple products. The current invention takes advantage of a seller's wish to sell a group of different products to one or multiple buyers, as long as makes profit on the total sale of such group of different products, rather than to make profit on each and every individual product in such group of different products.

### Description of the Prior Art

Group bidding or group purchase has been widely adopted by today's market to sell of various products and services. In most of group bidding system, seller sets a base price for a product or service, and allows multiple buyers to make bid for such product or service over a specific period of time. By the end of the day, the bidder with highest price purchases such product or service from seller.

Currently there are two major auction methods, which are represented by underlying patent for priceline U.S. Pat. No. 5,794,207, and groupon U.S. Pat. No. 6,269,343.

U.S. Pat. No. 5,794,207 issued to Walker et al. in 1998 discloses a method and apparatus for a cryptographically assisted commercial network system designed to facilitate buyer-driven conditional purchase offers. The invention is a method and apparatus for effectuating bilateral buyer-driven commerce. The invention allows prospective buyers of goods and services to communicate a binding purchase offer globally to potential sellers, for sellers conveniently to search for relevant buyer purchase offers, and for sellers potentially to bind a buyer to a contract based on the buyer's purchase offer. In a preferred embodiment, the apparatus of the invention includes a controller which receives binding purchase offers from prospective buyers. The controller makes purchase offers available globally to potential sellers. Potential sellers then have the option to accept a purchase offer and thus bind the corresponding buyer to a contract. The method and apparatus of the invention have applications on the Internet as well as conventional communications systems such as voice telephone.

U.S. Pat. No. 6,269,343 issued to Pallakoff in 2001 discloses an on-line marketing system and method. The invention provides a method and system that allows sellers to communicate conditional offers to potential buyers. The conditions include prices that depend on the aggregate amount of goods or services that buyers collectively agree to purchase by a given time and date. The invention facilitates “demand aggregation,” that is, aggregating demand by potential buyers (who may or may not know each other), for products offered by sellers. This invention allows sellers conveniently to offer “Demand-Based Pricing,” that is, prices which go down as the volume of units sold in a given offer goes up. A seller can therefore offer volume discounts to buyers acting as a group, even when the buyers may not have any formal relationship with one another.

U.S. Pat. No. 7,620,619 issued to Walker et al. in 2009 discloses a conditional purchase offer management system. A conditional purchase offer (CPO) management system is disclosed for receiving CPOs from one or more customers, such as airline passengers, and for evaluating the received CPOs against a number of CPO rules defined by a plurality of sellers, such as airlines, to determine whether any seller is willing to accept a given CPO. A CPO is a binding offer containing one or more conditions submitted by a customer for purchase of an item, such as airline travel, at a customer-defined price. A CPO rule is a set of restrictions defined by a given seller, such as an airline, to define a combination of restrictions for which the seller is willing to accept a predefined price. The CPO rules may be securely stored by one or more servers. The CPO management system permits a seller to correct for forecasting errors, if necessary, or other competitive forces which have produced excess capacity, by providing inventory for sale to CPO customers

U.S. Pat. Nos. 5,794,207 and 7,620,619 disclose inventions that allows one single buyer to make an offer to bid for the product or service the single buyer needed; the invention then auctions such bid to various available provider of such product or service; the acceptance of such bid by the first available provider concludes the process; and a contract is formed for the single buyer to purchase such product or service from that first available provider at the bidding price offered by the single buyer. Such invention allows the sellers of product and service to know the offer price to purchase product or service from each potential single buyer. The power to form the contract is in the hand of the sellers. The single buyer does not have any power to negotiate with seller, or push the seller to sell the product or service at certain price. This invention deals with the situation of one buyer facing multiple sellers to provide same product or service.

U.S. Pat. No. 6,269,343 discloses an invention that allows a group of buyers to purchase a product or service at a discounted price when certain aggregation in demand is reached. Such invention allows the seller to sell product or service at a pre-determined discounted price determined by seller upon reaching of certain demand aggregation. The buyers in this case do not have any power to negotiate with seller, or push the seller to sell the product or services at certain price. This invention deals with the situation of multiple buyers facing one seller of one product or service with predetermined number of buyers set by seller. This invention facilitates sales of product and service by the seller through demand aggregation that benefits seller only, because the selling price of the product and service was preset by seller before it communicates to the buyers.

The prior arts disclose two methods that are related to the present invention. One is priceline style that allows one buyer to make an offer to purchase one product or service from various sellers who might be willing to accept said buyer's offer. The other one is groupon style that allows one seller to make an offer to sell one product or service at a price with a condition that certain number of buyers are needed to purchase such product or service at same offered price from said seller within certain period of time. In priceline style, buyer would not be able to purchase the product or service, unless buyer's offer price is within seller's selling term. Therefore, all the buyers actually purchase the product or service at seller's willing-to-sell price. In groupon style, all the buyers actually purchase the product or service at seller's willing-to-sell price and at seller's willing-to-sell volume, otherwise, there would be no sell at all.

U.S. Patent Application Publication No. US 2012/0296761 A1 by Mayer in 2012 discloses a system and method for group bidding according to an overall group bid. The publication discloses a system and method for group bidding, in which the supplier accepts or reject the bids of the group as a group according to at least the overall group bid of the group, without being allowed to select or remove individual user bids, and optionally based upon one or more other characteristics of the group. A supplier is not permitted to remove one or more users from the group but instead accepts or rejects the bid of the group according to the overall group bid, such as a group average bid. The supplier is optionally permitted to make a counter offer with regard to the overall group bid, which has the effect of increasing reimbursement to the supplier, for example by increasing the overall group bid, such as for example by increasing the group average bid. This invention is only applicable for a group bidding of one single product, rather than a group of different products. The group average bid does not work for products with different pricing. Furthermore, the seller would not be able to protect its price bottom line by accepting group bidding of such method disclosed herein. Even the publication itself discloses that statistical bid analysis module may perform statistical analysis with regard to previously accepted group bids to predict the likelihood of a group average bid being accepted according to historical trends of such acceptance.

The prior arts also disclose other methods and systems related to the current invention.

U.S. Patent Application Publication No. US 2008/0126215 A1 by Orfaly in 2008 discloses a bidding method for buying products over the Internet. Such bidding method comprising: a. setting parameters fro a bid; b. opening the bid; c. accepting offers in the bid, if the offers conform to the predefined requirements and the parameters of the bid; d. closing the bid according to predefined requirements and the parameters of the bid; e. choosing a winner in the bid. The chosen winner is the offer which is closest to an average value of all the accepted offers.

U.S. Patent Application Publication No. US 2010/0180232 A1 by Honan et al. in 2010 discloses embodiments for identifying and grouping users of a system based on common interests and/or purchasing goals. In embodiments, one or more items of interested of a user are determined based on user input. A group is formed based on the one or more items of interest to the first user. At least a second user is identified based in part on at least one predetermined criterion and based in part on the second user having at least one or more items of interest corresponding to the one or more items of interest of the first user and the one or more items upon which the group was formed. Once the group is formed, the second user is automatically notified of the formation of the group a third user is identified based on at least a second one of a predetermined criterion and the third user is given access to the group.

U.S. Patent Application Publication No. US 2010/0318435 A1 by Ramanathan et al. in 2010 discloses a system to facilitate the interaction of a group of buyers and a group of sellers through a transaction network, such as the internet. A buyer may start a buying group or join an existing group for purchasing a product or service. During the life cycle of a buying group, buyers are encouraged to invite other buyers to join the group via email, blog, social networking websites, or other means, thereby increasing the purchasing power of that group. Once a buying group has been established, sellers can compete for the volume sale. Seller s may review the bid price submitted by other sellers and submit competing bids. Once the bid cycle closes, this system will automatically match the buyer san d sellers based on a variety of factors including the order each buyer entered his or her purchase intent, each buyer's maximum price, each seller's bidding price, the quantity each seller can provide, and the order of each seller's bid. At the end of the matching, one or more sellers may fulfill a single group order.

U.S. Patent Application Publication No. US 2012/0179502 A1 by Fakhrai et al. in 2012 discloses discount processing auction methods and systems, where buyers pool their purchasing power in order to get more competitive offers from sellers. Instead of sellers directly bidding for the buyer's shopping lists, the sellers update their discount rules and a discount processing method processes the sellers' latest discount rules and presents the results to the buyers while the auction is active. Buyers dynamically form a group and invite others to join the group to increase their purchasing power and maximize the discounts. Customers can form a social network with other buyers to share wish-lists, shopping carts, and discount scenarios. Customers who commit to buy a total number of items over a period fo time increase their effective purchasing power across time. Sellers also group together to offer higher total discount on a combination of items to buyers.

U.S. Patent Application Publication No. US 2014/0172611 A1 by Kaushik et al. in 2014 discloses a system and method of buyer-solicited offerings. Members of a buyers' group hosted at an online marketplace submit desired-item descriptions for items the desired purchase. The desired-item descriptions are developed into desired-item listings presented at the buyers' group Multiple buyers may be interested in the same desired-item listing and having expressed a purchase commitment for the item listing, their cumulative numbers as potential buyers may be displayed to sellers navigating the marketplace. A seller having a corresponding sale item to the desired-item may submit an item description that is developed into an item listing and containing an offer to sell the item. In this way buyers are able to attract offers to sell items that the buyers desire and by attracting multiple sellers bidding wars between sellers develop higher value deals for the buyers.

U.S. Patent Application Publication No. US 2015/0324860 and US 2015/0324933 A1 by Allen et al. in 2015 discloses a system, a method and a computer program product for creating the social group whose participants are involved in an online conversation. The system aggregates data associated with the online conversation and a group profile, of the social group. The system determines, based on the online conversation data and the group profile, a context of the online conversation and a goal of the social group. The system receives, based on the determined context and the goal, a first bidding from each provider, the first bidding associated with the determined context and the goal, the each provider providing one or more of goods, services or discounts associated with the context and the goal.

U.S. Patent Application Publication No. US 2016/0027078 A1 by Mesaros et al. in 2016 discloses a group buying system. Such group bidding system includes a search engine operable to present group purchasing events to consumers. Consumers utilizing the search engine supply criteria relating to product descriptions, purchasing terms, offer features or the like. The search engine retrieves group purchasing events from one or more sellers in accordance with the supplied criteria. Furthermore, mechanisms are provided to enable the search engine to discover new offers posted by sellers on other systems.

The seller or sellers of products or services only interested in making profits from selling products or services, but not intended to make profit on each and every sale of such products or services. As long as the seller or sellers of products or services makes profit on selling of multiple products or services in a single transaction, seller or sellers of products or services is willing to complete such transaction. Furthermore, as long as the seller or sellers of products or services makes profit on selling of products or services in multiple transactions within a pre-determined period, such as a day, a week, or a month, seller or sellers of products or services is willing to complete such transaction.

The buyer or buyers of products or services only interested in getting products or services at lowest possible price from the seller or sellers, as long as other terms associated with such products or services are same. The buyer or buyers of products or services always has or have such hesitation to make purchase offers sooner, because such buyer or buyers are always looking for better deals, which takes time and hold the buyer or buyers back from making purchase offers.

What is needed then is a system and method to help buyers to take advantage of demand aggregation to push sellers of products and services to compete among each other to provide buyers with the best possible price, and at the same time, seller would have a choice to decrease the selling price further when the sales volume increases, and allow buyers in the previous sale section to enjoy the further discount associated with the increase of the total sales volume.

Accordingly, it is a principal objective of my invention to provide a group bidding system and method that is capable of aggregating demand for multiple products or services from various buyers to form a buying group for such multiple products or services.

It is a further objective of my invention to provide a group bidding system and method that is capable of aggregating different prices for such multiple products or services from various buyers to form a total offer price.

It is a still further objective of my invention to provide a group bidding system and method that is capable of communicating such aggregated demand and such total conditional offer price to one seller or multiple sellers of such product or service, without the need for seller or sellers to disclose the average willing-to-sell price for each individual product or service.

It is a still further objective of my invention to provide a group bidding system and method that is capable of providing negotiation leverage on behalf of the buyers, without the need for seller or sellers to disclose the average willing-to-sell price for each individual product or service.

It is a still further objective of my invention to provide a group bidding system and method that is capable of helping all or some of the buyers to purchase multiple products or services at buyer's offer price, without the need for seller or sellers to disclose the average willing-to-sell price for each individual product or service.

It is a still further objective of my invention to provide a group bidding system and method that buyers making purchase offers do not need to disclose willing-to-buy prices for products or services, but only the demand for such products or services, and that only sellers of such products or services competing for such purchase offers.

It is a still further objective of my invention to provide a group bidding system and method that is capable of providing buyers with motivation to make purchase offers to the seller or sellers without the risk that such seller or sellers might accept a lower selling price for such products or services at a later time, because more of products or services are sold in the future.

Other objects of my invention, as well as particular features, elements, and advantages thereof, will be elucidated in, or apparent from, the following description and the accompanying drawing figures.

### SUMMARY OF THE INVENTION

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to my present invention, I have provided a group bidding system and method capable of providing buyer motivation to make purchase offers of multiple products and services and aggregating said purchase offers of multiple products and services from one buyer or multiple buyers and bidding such purchase offers to one seller or multiple sellers of said multiple products or services.

The present invention provides a group bidding system capable of providing buyer motivation to make purchase offers of multiple products and services and aggregating said purchase offers of multiple products and services from one buyer or multiple buyers and bidding such purchase offers to one seller or multiple sellers of said multiple products or services. Said group bidding system comprises a central control system, said central control system capable of receiving and processing said purchase offers of said multiple products and services and communicating sum of said purchase offers and related information to said one seller or said multiple sellers of said multiple products or services; a buyer interface, said buyer interface being controlled by said central control system, and through which said one buyer or said multiple buyers being able to communicate said purchase offers to said central control system; a seller interface, said seller interface being controlled by said central control system, and through which said one seller or said multiple sellers being able to receive said sum of said purchase offers and said related information from said central control system, and accept or reject or make counter offer to or make suggestion towards said sum of said purchase offers; a database, said database being controlled and accessed by said central control system, and having information related to said purchase offers; a credit verification interface, said credit verification interface being accessed by said central control system, said one buyer or said multiple buyers, and said one seller or said multiple sellers; and a payment interface, said payment interface being accessed by said central control system, said one buyer or said multiple buyers, and said one seller or said multiple sellers.

Said central control system of the group bidding system is capable of processing said purchase offers of multiple products or services from said one buyer or said multiple buyers within a bidding period according to a first set of pre-determined rules, said first set of pre-determined rules including at least a process to categorize said purchase offers of said multiple products or services into multiple categories, and arrange said purchase offers of said multiple products or services in each of said multiple categories from highest purchase offer to lowest purchase offer, and communicating sum of said purchase offers and number of units in each of said multiple categories to said one seller or said multiple sellers of said multiple products or services.

Said central control system of the group bidding system has an option to disclose said purchase offers of said multiple products or services to said one buyer or said multiple buyers, and allows said one buyer or said multiple buyers with said lowest purchase offer to increase said lowest purchase offer to a higher purchase offer within said bidding period.

Said central control system of the group bidding system is capable of repeating a routine of process of communicating said sum of said purchase offers and number of units in each of said multiple categories to said one seller or said multiple sellers of said multiple products or services according to a second set of pre-determined rules within said bidding period, said second set of pre-determined rules including exclusion of at least one of said multiple products or services with said lowest purchase offer from at least one of said multiple categories before repeating said routine of process of communicating said sum of said purchase offers and number of units in each of said multiple categories to said one seller or said multiple sellers, said one seller or said multiple sellers being able to either accept or reject said sum of said purchase offers and number of units of said multiple categories altogether, until said sum of said purchase offers being accepted by said one seller or said multiple sellers, or all of said purchase offers being excluded from said sum of said purchase offers.

Said central control system of the group bidding system is capable of establishing a transaction period, said transaction period having more than one said bidding period, said one buyer or said multiple buyers whose purchase offers being accepted by said seller or said multiple sellers in a previous bidding period being substituted by purchase offers accepted by said seller or said multiple sellers in a later bidding period, if said purchase offers accepted by said seller or said multiple sellers in said later bidding period being better than said purchase offers accepted by said seller or said multiple sellers in said previous bidding period according to a third set of per-determined rules.

Said one buyer or said multiple buyers of the group bidding system, whose said purchase offers being accepted by said one seller or said multiple sellers, cannot withdraw said purchase offers upon acceptance by said one seller or said multiple sellers.

The present invention provides a group bidding method capable of providing buyer motivation to make purchase offers of multiple products and services and aggregating said purchase offers of multiple products or services from one buyer or multiple buyers and communicating such purchase offers to one seller or multiple sellers of said multiple products or services. Said group bidding method comprises establishing a bidding period; establishing a transaction period, said transaction period having one or more said bidding periods; starting said bidding period; gathering purchase offers from said one buyer or said multiple buyers for said multiple products or services by a central control system within said bidding period; processing said purchase offers by said central control system according to a first set of pre-determined rules, said first set of pre-determined rules including at least a process to categorize said purchase offers of said multiple products or services into multiple categories, and arrange said purchase offers of said multiple products or services in each of said multiple categories from highest purchase offer to lowest purchase offer within said bidding period; communicating sum of said purchase offers and number of units in each of said multiple categories by said central control system to said one seller or said multiple sellers of said multiple products or services within said bidding period; receiving a decision, said decision being either an acceptance or rejection or counter offer or suggestion, by said central control system from said one seller or said multiple sellers within said bidding period; communicating said decision by said central control system to said one buyer or said multiple buyers within said bidding period; closing said bidding period; and closing said transaction period upon completion all bidding periods within said transaction period.

Said central control system of the group bidding method comprises a database, said database being controlled and accessed by said central control system, and having information related to said purchase offers, said one buyer or said multiple buyers, and said one seller or said multiple sellers; a buyer interface, said buyer interface being controlled by said central control system, and accessed by both said central control system and said one buyer or said multiple buyers; a seller interface, said seller interface being controlled by said central control system, and accessed by both said central control system and said one seller or said multiple sellers; a credit verification interface, said credit verification interface being accessed by said central control system, said one buyer or said multiple buyers, and said one seller or said multiple sellers; and a payment interface, said payment interface being accessed by said central control system, said one buyer or said multiple buyers, and said one seller or said multiple sellers.

Said central control system of the group bidding is capable of repeating a routine of process of communicating said sum of said purchase offers and number of units in each of said multiple categories to said one seller or said multiple sellers of said multiple products or services according to a second set of pre-determined rules, said second set of pre-determined rules including exclusion of at least one of said multiple products or services with said lowest purchase offer from at least one of said multiple categories before repeating said routine of process of communicating said sum of said purchase offers and number of units in each of said multiple categories to said one seller or said multiple sellers, until said sum of said purchase offers being accepted by said one seller or said multiple sellers, or all of said purchase offers being excluded from said sum of said purchase offers.

Said central control system of the group bidding method is capable of establishing a transaction period, said transaction period having more than one said bidding period, said one buyer or said multiple buyers whose purchase offers being accepted by said seller or said multiple sellers in a previous bidding period shall be substituted by purchase offers accepted by said seller or said multiple sellers in a later bidding period, if said purchase offers accepted by said seller or said multiple sellers in said later bidding period being better than said purchase offers accepted by said seller or said multiple sellers in said previous bidding period according to a third set of per-determined rules.

Said purchase offers of said multiple products or services from said one buyer or said multiple buyers include different offer prices of said multiple products or services.

Each of said multiple sellers of said multiple products or services can provide at least one of said multiple products or services.

Said one buyer or said multiple buyers, whose purchase offers being accepted by said one seller or said multiple sellers, cannot withdraw said purchase offers upon acceptance by said one seller or said multiple sellers.

Said central control system of the group bidding method has an option to disclose said purchase offers of said multiple products or service to said one buyer or said multiple buyers, and allows said one buyer or said multiple buyers with said lowest purchase offer to increase said lowest purchase offer to a higher purchase offer.

The present invention also provides another group bidding method capable of providing buyer motivation to make purchase offers of multiple products and services and aggregating said purchase offers of multiple products or services from multiple buyers and communicating such purchase offers to multiple sellers of said multiple products or services. Said group bidding method comprises establishing a transaction period; starting said transaction period; establishing a list of products or services, each of said list of products or services having various associated terms, said various associated terms including at least a ceiling price for said product or service and a delivery term; establishing a first bidding period with a first starting time and a first ending time, a second bidding period with a second starting time and a second ending time, and a third bidding period with a third starting time and a third ending time, said second ending time being no earlier than said first ending time, said third ending time being no earlier than said second ending time, said first bidding period, said second bidding period and said third bidding period being a part of said transaction period; starting said first bidding period at said first starting time; gathering first purchase offers from one or more of said multiple buyers for each of said list of products or services by a central control system within said first bidding period, said first purchase offers including a first purchase number of units associated with each of said list of products or services and excluding price; communicating said first purchase offers by said central control system to each of said multiple sellers of said list of products or services within said first bidding period, each of said multiple sellers being able to provide at least one of said list of products or services; receiving a group of first bids from some or all of said multiple sellers for some or all of said first purchase offers, each of said multiple sellers being able to provide only one first bid each time for some or all of each of said list of products or services, said group of first bids being available to each of said multiple sellers, said multiple sellers being provided opportunities to modify its own said first bid for some or all of each of said list of products or services repeatedly until said first bid being finalized by each of said multiple sellers, each of said group of first bids including a first bid price and for a first bid number of units associated with said first bid price and meeting all requirements of said various associated terms, said first bid price being no higher than said ceiling price, said first bid number being no more than said first purchase number; communicating a group of first bidding period bids by said central control system to said multiple buyers within said first bidding period, said group of first bidding period bids including the best bid from said group of first bids defined by said various associated terms for each of said list of products or services; forming a first contract to fill said first purchase offers by said group of first bidding period bids, said one buyer or said multiple buyers cannot withdraw said first purchase offers upon forming said first contract for said group of first bidding period bids; closing said first bidding period at said first ending time; starting said second bidding period at said second starting time, said second starting time being before, same as or later than said first starting time; gathering second purchase offers from one or more of said multiple buyers for each of said list of products or services by said central control system within said second bidding period, said second purchase offers including a second purchase number of units associated with each of said list of products or services and excluding price; communicating said second purchase offers by said central control system to each of said multiple sellers of said list of products or services within said second bidding period, each of said multiple sellers being able to provide at least one of said list of products or services; receiving a group of second bids from some or all of said multiple sellers for some or all of said second purchase offers, each of said multiple sellers being able to provide only one second bid each time for some or all of each of said list of products or services, said group of second bids being available to each of said multiple sellers, said multiple sellers being provided opportunities to modify its own said second bid for some or all of each of said list of products or services repeatedly until said second bid being finalized by each of said multiple sellers, each of said group of second bids including a second bid price and for a second bid number of units associated with said second bid price and meeting all requirements of said various associated terms, said second bid price being no higher than said ceiling price, said second bid number being no more than said second purchase number; communicating a group of second bidding period bids by said central control system to said multiple buyers within said second bidding period, said group of second bidding period bids including the best bid from said group of second bids defined by said various associated terms for each of said list of products or services; forming a second contract to fill said second purchase offers by said group of second bidding period bids, said one buyer or said multiple buyers cannot withdraw said second purchase offers upon forming said second contract for said group of second bidding period bids; closing said second bidding period at said second ending time; replacing said first bid in said first bidding period bids of said first contract with said second bid in said second bidding period bids, if both said first bid and said second bid being for same product or service, and said second bid being better than said first bid defined by said various associated terms; starting said third bidding period at said third starting time, said third starting time being before, same as or later than said second starting time; gathering third purchase offers from one or more of said multiple buyers for each of said list of products or services by said central control system within said third bidding period, said third purchase offers including a third purchase number of units associated with for each of said list of products or services and excluding price; communicating said third purchase offers by said central control system to each of said multiple sellers of said list of products or services within said third bidding period, each of said multiple sellers being able to provide at least one of said list of products or services; receiving a group of third bids from some or all of said multiple sellers for some or all of said third purchase offers, each of said multiple sellers being able to provide only one third bid each time for some or all of each of said list of products or services, said group of third bids being available to each of said multiple sellers, said multiple sellers being provided opportunities to modify its own said third bid for some or all of each of said list of products or services repeatedly until said third bid being finalized by each of said multiple sellers, each of said group of third bids including a third bid price and for a third bid number of units associated with said third bid price and meeting all requirements of said various associated terms, said third bid price being no higher than said ceiling price, said third bid number being no more than said third purchase number; communicating a group of third bidding period bids by said central control system to said multiple buyers within said third bidding period, said group of third bidding period bids including the best bid from said group of third bids defined by said various associated terms for each of said list of products or services; forming a third contract to fill said third purchase offers by said group of third bidding period bids, said one buyer or said multiple buyers cannot withdraw said third purchase offers upon forming said third contract for said group of third bidding period bids; closing said third bidding period at said third ending time; replacing said first bid in said first bidding period bids of said first contract with said third bid in said third bidding period bids, if all said first bid, said second bid and said third bid being for same product or service, and said third bid being better than said first bid and said second bid defined by said various associated terms; replacing said second bid in said second bidding period bids of said second contract with said third bid in said third bidding period bids, if both said second bid and said third bid being for same product or service, and said third bid being better than said second bid defined by said various associated terms; and closing said transaction period.

Said group of first bidding period bids, said group of second bidding period bids, and said group of third bidding period bids can cover a part or all of said first purchase offers, said second purchase offers, and said third purchase offers, and be provided by one or some of said multiple sellers jointly.

Said third bidding period can be a plurality of bidding periods with its own starting time and ending time, all of which being within said transaction period and having all features of said third bidding period.

The present invention also provides another group bidding system capable of providing buyer motivation to make purchase offers of multiple products and services and aggregating said purchase offers of multiple products or services from multiple buyers and communicating such purchase offers to multiple sellers of said multiple products or services. Said group bidding system comprises means and computer means for establishing a transaction period; means and computer means for starting said transaction period; means and computer means for establishing a list of products or services, each of said list of products or services having various associated terms, said various associated terms including at least a ceiling price for said product or service and a delivery term; means and computer means for establishing a first bidding period with a first starting time and a first ending time, a second bidding period with a second starting time and a second ending time, and a third bidding period with a third starting time and a third ending time, said second ending time being no earlier than said first ending time, said third ending time being no earlier than said second ending time, said first bidding period, said second bidding period and said third bidding period being a part of said transaction period; means and computer means for starting said first bidding period at said first starting time; means and computer means for gathering first purchase offers from one or more of said multiple buyers for each of said list of products or services by a central control system within said first bidding period, said first purchase offers including a first purchase number of units associated with each of said list of products or services and excluding price; means and computer means for communicating said first purchase offers by said central control system to each of said multiple sellers of said list of products or services within said first bidding period, each of said multiple sellers being able to provide at least one of said list of products or services; means and computer means for receiving a group of first bids from some or all of said multiple sellers for some or all of said first purchase offers, each of said multiple sellers being able to provide only one first bid each time for some or all of each of said list of products or services, said group of first bids being available to each of said multiple sellers, said multiple sellers being provided opportunities to modify its own said first bid for some or all of each of said list of products or services repeatedly until said first bid being finalized by each of said multiple sellers, each of said group of first bids including a first bid price and for a first bid number of units associated with said first bid price and meeting all requirements of said various associated terms, said first bid price being no higher than said ceiling price, said first bid number being no more than said first purchase number; means and computer means for communicating a group of first bidding period bids by said central control system to said multiple buyers within said first bidding period, said group of first bidding period bids including the best bid from said group of first bids defined by said various associated terms for each of said list of products or services; means and computer means for forming a first contract to fill said first purchase offers by said group of first bidding period bids, said one buyer or said multiple buyers cannot withdraw said first purchase offers upon forming said first contract for said group of first bidding period bids; means and computer means for closing said first bidding period at said first ending time; means and computer means for starting said second bidding period at said second starting time, said second starting time being before, same as or later than said first starting time; means and computer means for gathering second purchase offers from one or more of said multiple buyers for each of said list of products or services by said central control system within said second bidding period, said second purchase offers including a second purchase number of units associated with each of said list of products or services and excluding price; means and computer means for communicating said second purchase offers by said central control system to each of said multiple sellers of said list of products or services within said second bidding period, each of said multiple sellers being able to provide at least one of said list of products or services; means and computer means for receiving a group of second bids from some or all of said multiple sellers for some or all of said second purchase offers, each of said multiple sellers being able to provide only one second bid each time for some or all of each of said list of products or services, said group of second bids being available to each of said multiple sellers, said multiple sellers being provided opportunities to modify its own said second bid for some or all of each of said list of products or services repeatedly until said second bid being finalized by each of said multiple sellers, each of said group of second bids including a second bid price and for a second bid number of units associated with said second bid price and meeting all requirements of said various associated terms, said second bid price being no higher than said ceiling price, said second bid number being no more than said second purchase number; means and computer means for communicating a group of second bidding period bids by said central control system to said multiple buyers within said second bidding period, said group of second bidding period bids including the best bid from said group of second bids defined by said various associated terms for each of said list of products or services; means and computer means for forming a second contract to fill said second purchase offers by said group of second bidding period bids, said one buyer or said multiple buyers cannot withdraw said second purchase offers upon forming said second contract for said group of second bidding period bids; means and computer means for closing said second bidding period at said second ending time; means and computer means for replacing said first bid in said first bidding period bids of said first contract with said second bid in said second bidding period bids, if both said first bid and said second bid being for same product or service, and said second bid being better than said first bid defined by said various associated terms; means and computer means for starting said third bidding period at said third starting time, said third starting time being before, same as or later than said second starting time; means and computer means for gathering third purchase offers from one or more of said multiple buyers for each of said list of products or services by said central control system within said third bidding period, said third purchase offers including a third purchase number of units associated with for each of said list of products or services and excluding price; means and computer means for communicating said third purchase offers by said central control system to each of said multiple sellers of said list of products or services within said third bidding period, each of said multiple sellers being able to provide at least one of said list of products or services; means and computer means for receiving a group of third bids from some or all of said multiple sellers for some or all of said third purchase offers, each of said multiple sellers being able to provide only one third bid each time for some or all of each of said list of products or services, said group of third bids being available to each of said multiple sellers, said multiple sellers being provided opportunities to modify its own said third bid for some or all of each of said list of products or services repeatedly until said third bid being finalized by each of said multiple sellers, each of said group of third bids including a third bid price and for a third bid number of units associated with said third bid price and meeting all requirements of said various associated terms, said third bid price being no higher than said ceiling price, said third bid number being no more than said third purchase number; means and computer means for communicating a group of third bidding period bids by said central control system to said multiple buyers within said third bidding period, said group of third bidding period bids including the best bid from said group of third bids defined by said various associated terms for each of said list of products or services; means and computer means for forming a third contract to fill said third purchase offers by said group of third bidding period bids, said one buyer or said multiple buyers cannot withdraw said third purchase offers upon forming said third contract for said group of third bidding period bids; means and computer means for closing said third bidding period at said third ending time; means and computer means for replacing said first bid in said first bidding period bids of said first contract with said third bid in said third bidding period bids, if all said first bid, said second bid and said third bid being for same product or service, and said third bid being better than said first bid and said second bid defined by said various associated terms; means and computer means for replacing said second bid in said second bidding period bids of said second contract with said third bid in said third bidding period bids, if both said second bid and said third bid being for same product or service, and said third bid being better than said second bid defined by said various associated terms; and means and computer means for closing said transaction period.

Said group of first bidding period bids, said group of second bidding period bids, and said group of third bidding period bids can cover a part or all of said first purchase offers, said second purchase offers, and said third purchase offers, and be provided by one or some of said multiple sellers jointly.

Said third bidding period can be a plurality of bidding periods with its own starting time and ending time, all of which being within said transaction period and having all features of said third bidding period.

The present invention can also be used to group buyers for various products and services, including electronics, equipments, grocery, stationery, restaurants, airline tickets, hotels, shipping, cell phone services, etc.

The present invention can further help department store type of providers to better serve the market by selling the most products to the buyers. For example, an electronic device store, such as Best Buy, is able to take advantage of the present invention to sell its products to the buyers. The present invention is able to aggregate the demand of various products from various buyers, such as demand of three lap top computers, two flat screen TV, five different type of refrigerators, add the bid prices of all these products, and bid such total prices and total demand to Best Buy. As long as Best Buy is able to make profit from the sale of all these products at the total prices, Best Buy will make the sale without caring about whether each of such sale will make profit.

Other technical advantages will be readily apparent to one skilled in the art from the following figures, descriptions and claims. Moreover, while specific advantages have been enumerated above, various embodiments may include all, some or one of the enumerated advantages.

Embodiments may be implemented as a computer, a computer process, a computing system or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instruction for executing a computer process.

### DESCRIPTION OF THE DRAWINGS

Other features of my invention will become more evident from a consideration of the following detailed description of my patent drawings, as follows:

FIG. 1 is a structure demonstration drawing of the preferred embodiment of current invention;

FIG. 2 is a flow chart for the first preferred embodiment of the group bidding method of current invention.

FIG. 3 is a flow chart for the second preferred embodiment of the group bidding method of current invention.

FIG. 4 is a sample illustration of transaction in one single bidding period.

### DETAILED DESCRIPTION OF THE PREFERRED EMBODIMENT

Various embodiments are described more fully below with reference to the accompanying drawings, which form a part hereof, and which show specific embodiments for practicing the embodiments described herein. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems, or devices. Accordingly, embodiments may take the form of a hardware implementation, an entirely software implementation or an implementation combing software and hardware aspects.

Referring now to the drawings, my invention concerns a group bidding system capable of providing buyer motivation to make purchase offers of multiple products and services and aggregating said purchase offers of multiple products and services from one buyer or multiple buyers and bidding such purchase offers to one seller or multiple sellers of said multiple products or services.

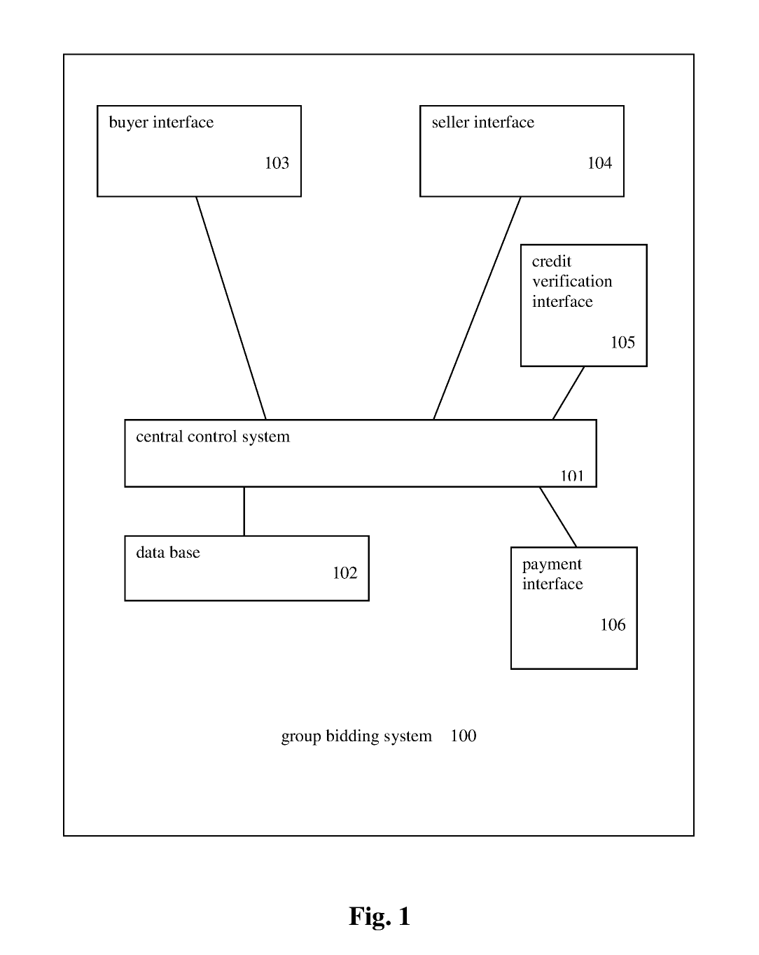

Referring now to FIG. 1, which is a structure demonstration drawing of a first preferred embodiment of current invention of group bidding system 100. Said group bidding system 100 comprises a central control system 101, said central control system 101 capable of receiving and processing said purchase offers of said multiple products and services and communicating sum of said purchase offers and related information to said one seller or said multiple sellers of said multiple products or services; a buyer interface 103, said buyer interface 103 being controlled by said central control system 101, and through which said one buyer or said multiple buyers being able to communicate said purchase offers to said central control system 101; a seller interface 104, said seller interface 104 being controlled by said central control system 101, and through which said one seller or said multiple sellers being able to receive said sum of said purchase offers and said related information from said central control system 101, and accept or reject or make counter offer to or make suggestion towards said sum of said purchase offers; a database 102, said database 102 being controlled and accessed by said central control system 101, and having information related to said purchase offers; a credit verification interface 105, said credit verification interface 105 being accessed by said central control system 101, said one buyer or said multiple buyers, and said one seller or said multiple sellers; and a payment interface 106, said payment interface 106 being accessed by said central control system 101, said one buyer or said multiple buyers, and said one seller or said multiple sellers.

Said central control system 101 is capable of processing said purchase offers of multiple products or services from said one buyer or said multiple buyers within a bidding period according to a first set of pre-determined rules, said first set of pre-determined rules including at least a process to categorize said purchase offers of said multiple products or services into multiple categories, and arrange said purchase offers of said multiple products or services in each of said multiple categories from highest purchase offer to lowest purchase offer, and communicating sum of said purchase offers and number of units in each of said multiple categories to said one seller or said multiple sellers of said multiple products or services.

Said central control system 101 has an option to disclose said purchase offers of said multiple products or services to said one buyer or said multiple buyers, and allows said one buyer or said multiple buyers with said lowest purchase offer to increase said lowest purchase offer to a higher purchase offer within said bidding period.

Said central control system 101 is capable of repeating a routine of process of communicating said sum of said purchase offers and number of units in each of said multiple categories to said one seller or said multiple sellers of said multiple products or services according to a second set of pre-determined rules within said bidding period, said second set of pre-determined rules including exclusion of at least one of said multiple products or services with said lowest purchase offer from at least one of said multiple categories before repeating said routine of process of communicating said sum of said purchase offers and number of units in each of said multiple categories to said one seller or said multiple sellers, said one seller or said multiple sellers being able to either accept or reject said sum of said purchase offers and number of units of said multiple categories altogether, until said sum of said purchase offers being accepted by said one seller or said multiple sellers, or all of said purchase offers being excluded from said sum of said purchase offers.

Said central control system 101 is capable of establishing a transaction period, said transaction period having more than one said bidding period, said one buyer or said multiple buyers whose purchase offers being accepted by said seller or said multiple sellers in a previous bidding period being substituted by purchase offers accepted by said seller or said multiple sellers in a later bidding period, if said purchase offers accepted by said seller or said multiple sellers in said later bidding period being better than said purchase offers accepted by said seller or said multiple sellers in said previous bidding period according to a third set of per-determined rules.

Said one buyer or said multiple buyers, whose said purchase offers being accepted by said one seller or said multiple sellers, cannot withdraw said purchase offers upon acceptance by said one seller or said multiple sellers.

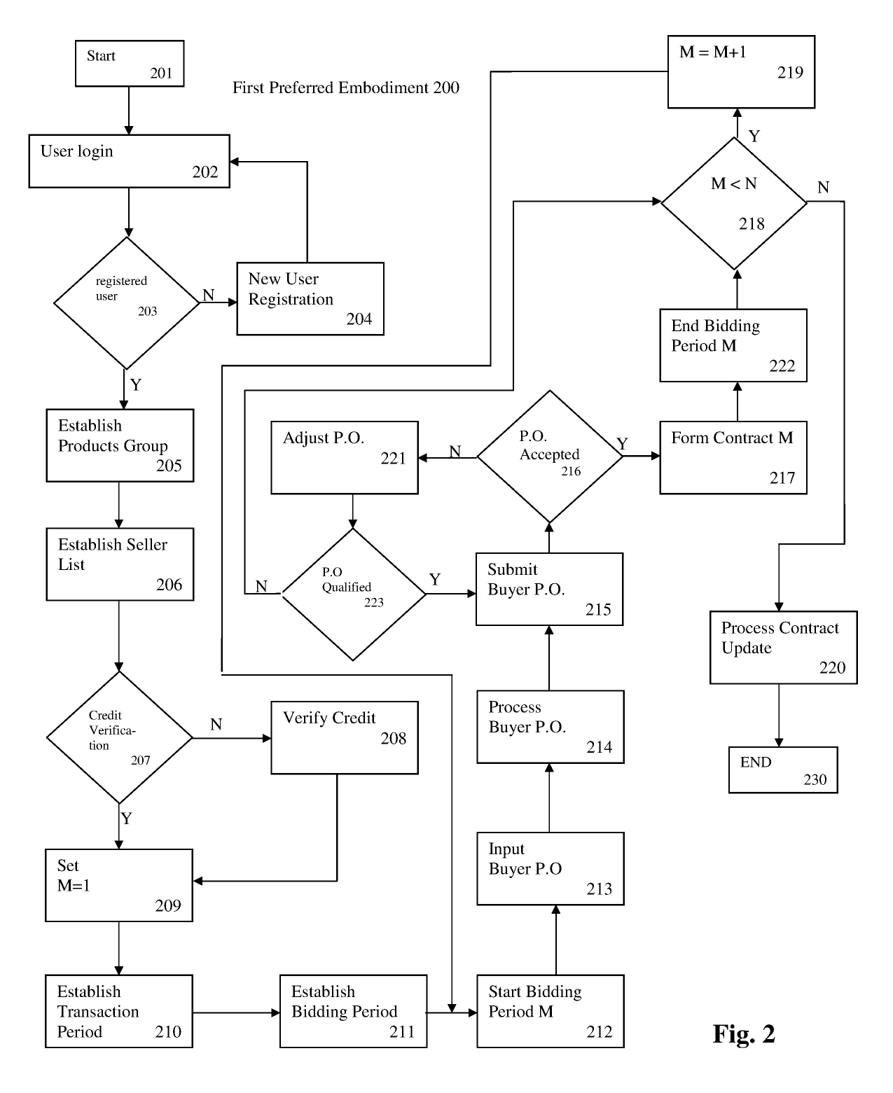

Referring now to FIG. 2, which is a first preferred embodiment of current invention of group bidding method 200. Said group bidding method is processed by said central control system 101. Said group bidding method 200 is capable of providing buyer motivation to make purchase offers of multiple products and services and aggregating said purchase offers of multiple products or services from one buyer or multiple buyers and communicating such purchase offers to one seller or multiple sellers of said multiple products or services.

Said group bidding method starts at step 201 and proceed to step 202. At step 202, said method enables various users, including both buyers and sellers, to login and then proceed to step 203. At step 203, said method verifies whether the user has been registered and has access authorization. If the answer at step 203 is no, the method proceeds to step 204. At step 204, the method enables user to register, and proceed back to step 202. If the answer at step 203 is yes, the method proceeds to step 205. At step 205, the method establish products group for users, and proceed to step 206. Such products group can be established by either buyer or seller. At step 206, the method establish a seller list, including the available sellers who are able to provide all the products of such products group, and proceed to step 207. At step 207, said method verifies whether the buyers and sellers meet the credit requirements. If the answer at step 207 is no, the method proceeds to step 208. At step 208, the method verifies the needed credit information for the buyers and sellers and proceeds to step 209. If the answer at step 207 is yes, the method proceeds to step 209. At step 209, the method set M=1, and proceeds to step 210. At step 210, the method establishes a transaction period, and proceeds to step 211. Such transaction period includes N bidding periods, each of which has its own starting time and ending time. At step 211, categorize these bidding periods with the first bidding period having an earliest ending time and the Nth bidding period with the latest ending time, and proceeds to step 212. At step 212, the method starts bidding period 1, and proceeds to step 213. At step 213, the method enables buyers to input purchase offers from buyers for each product of products group, as well as number of units associated therewith, and proceed to step 214. All the purchase offers shall be binding on buyers during the bidding period. At step 214, the method processes purchase offers and arranges said purchase offers from highest purchase offer to lowest purchase offer for each product of products group within said bidding period, and proceeds to step 215. At step 215, the method communicates purchase offers to all the sellers, and proceeds to step 216. At step 216, the method allows each of sellers or multiple sellers jointly to either accept purchase offers in its entirety, or reject purchase offers. If the purchase offer is rejected by all sellers at step 216, the method proceeds to step 221. At step 221, the method adjusts purchase orders by taking out at least one purchase offer with the lowest offer price for one product of products list, and proceeds to step 223. At step 223, the method determines if the purchase offers includes at least one product of products group. If the answer is yes at step 223, the method proceeds to step 215. If the answer is no at step 223, the method proceeds to step 218. If the purchase offer is accepted by one seller at step 216, the method proceeds to step 217. At step 217, the method forms contract M between buyers and seller for the purchase offers associated with the products group, and proceeds to step 222. At step 222, the method ends bidding period M, and proceeds to step 218. At step 218, the method determines if M is less than N. If the answer is yes at step 218, the method proceeds to step 219. At step 219, the method increases M by one, and proceeds to step 212. If the answer is no at step 218, the method proceeds to step 220. At step 220, the method process contract updates for all M contracts, and informs buyers whose purchase offers being accepted by said seller or said multiple sellers in a previous bidding period shall be substituted by purchase offers accepted by said seller or said multiple sellers in a later bidding period, if said purchase offers accepted by said seller or said multiple sellers in said later bidding period being better than said purchase offers accepted by said seller or said multiple sellers in said previous bidding period. The definition of better is defined before the starting of any bidding period. The method then proceeds to the end at step 230. The products group can be services group or a combination of products and services group.

This first preferred embodiment of current invention of group bidding method 200 can be used in the area of appliance retail. This group bidding method 200 is capable of providing buyer motivation to make purchase offers of various appliances and aggregating said purchase offers for appliance retailers to compete for such purchase offers. A website can be established for buyers and sellers of various appliances. Buyers shall be able to register and login to the website to make purchase offers. For example, there are thirty buyers, each of whom needs to purchase at least one model A washer or one model B dryer. There are three retailers, retailer A, retailer B and retailer C, each of which can provide such model A washer and model B dryer. In a first transaction, there are ten buyers, each of whom needs to purchase one model A washer; there are ten buyers, each of whom needs to purchase one model B dryer; and there are ten buyers, each of whom needs to purchase one model A washer and one model B dryer. The method is able to aggregate the total demand from all thirty buyers, which includes 20 model A washers and 20 model B dryers, each of which has one price offered by one of the buyers. The method is able to provide each of the three retailers with the total prices offered by thirty buyers for total of 20 model A washers and 20 model B dryers. A retailer, e.g. retailer A, who is able to accept the total prices offered by thirty buyers for total of 20 model A washers and 20 model B dryers will win the deal and make sales thereof to the thirty buyers. If later on in a second transaction, more buyers purchase more model A washers and model B dryers from retailer A, there are three possible outcomes for model A washers. First outcome, the average price of all the model A washers to be sold at the second transaction is the same as those of the first transaction. Second outcome, the average price of all the model A washers to be sold at the second transaction is less expensive than those of the first transaction. Third outcome, the average price of all the model A washers to be sold at the second transaction are more expensive than those of the first transaction. In first outcome, there is nothing needs to be done. In second outcome, because retailer A is willing to sell the same product in a second transaction at a lower average price, such lower average price shall be enjoyed by the buyers in the first transaction as well. As there result, those buyers in the first transaction shall be credited for the difference between the average price in the first transaction and the average price in the second transaction. In third outcome, because the average price in the second transaction is higher than the average price in the first transaction, nothing needs to be done further.

Theoretically, a retailer usually gets lower and lower per unit cost when more and more units are sold. Therefore, there are more incentives for a retailer to provide a possible lower price for a same product, when more of such products are sold. Because a buyer understands such rationale the retailer has, buyer usually wants to wait at a later time to make a purchase, if such purchase can be waited. By adopting current invention, a potential buyer does not need to wait to make a purchase, because such buyer would be able to enjoy a lower price anyway, if such price can be provided by the retailer to a future buyer, as long as a period is pre-defined to include both such earlier purchase and later purchase. Bu adopting current invention, it also helps the retailer to have more sales faster and earlier.

This first preferred embodiment of current invention of group bidding method 200 can be used in the area of grocery retail. This group bidding method 200 is capable of providing buyer motivation to make purchase offers of various grocery items and aggregating said purchase offers for grocery retailers to compete for such purchase offers. Various consumers in a defined region can log on to a website to make purchase offers for various grocery items, such as milk, egg, and tomato. The website can integrate all those offer into total amount of milk with total price, total amount of eggs with total price and total amount of tomato with total price. Then such offer, which can be defined as a first transaction, can be provided to different grocery stores in the same region. If one grocery store accepts such purchase offer from these consumers, those consumers will be able to go to such grocery store and retrieve those items at their respective prices offered for their respective items. For the same token, in a second transaction, the grocery store might be able to provide mile, egg, and tomato at a lower per unit price, because more orders from consumers. The invention provides the consumers in the first transaction to be able to enjoy the lower price of those in the second transaction. The grocery store has its owner delivery schedule, and usually can only estimate the purchase in advance to make order and delivery of various products to the grocery store. As long as the first transaction and the second transaction are within same delivery period, the grocery store can order those together and make a same delivery to the store. This invention helps the consumer to make purchase decision earlier, rather than later, because consumers will enjoy the same price anyway, if later on the price will be lower for the same product. This invention also helps the retailer to get the sales earlier, rather than wait until a later time. Theoretically, the more units ordered for each product, the lower the cost to the grocery store for each unit. Such invention provides a mechanism to give consumer incentive to make a purchase earlier and for the consumer to be able to enjoy the cost benefit the retailer shall have by integrated all the consumer demand within a pre-defined period, such as the period between the wholesale delivery of the grocery store.

This invention can be used for stationery, printing supplies, tonners, paper, restaurant dining, and countless other places.

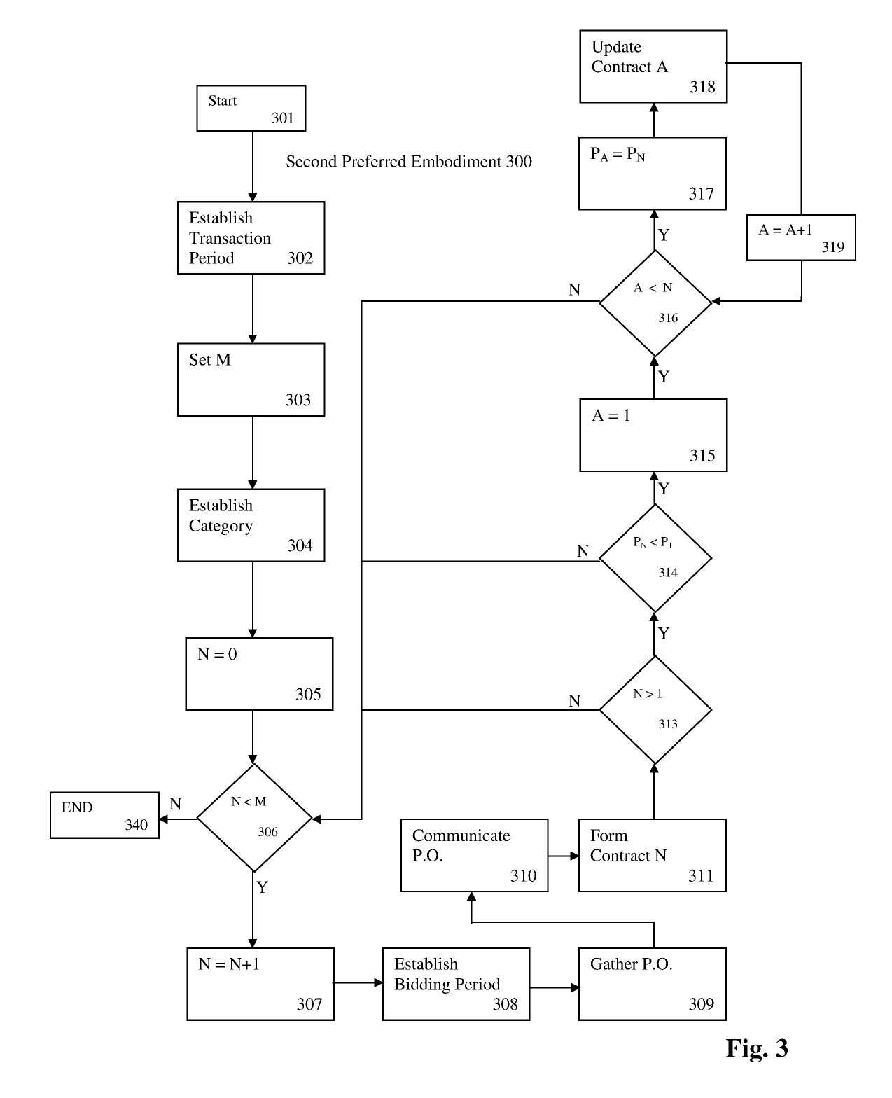

Referring now to FIG. 3, which is a second preferred embodiment of current invention of group bidding method 300. Said group bidding method 300 is capable of providing buyer motivation to make purchase offers of multiple products and services and aggregating said purchase offers of multiple products or services from one buyer or multiple buyers and communicating such purchase offers to one seller or multiple sellers of said multiple products or services.

Said group bidding method 300 starts at step 301 and proceeds to step 302. At step 302, such method establishes a transaction period, and then proceeds to step 303. At step 303, the method set up a value for M, and proceeds to step 304. At step 304, the method establishes a product or service category, said product or service category having a product or service, said product or service having various associated terms, said various associated terms including at least a ceiling price for said product or service, and proceed to step 305. At step 305, the method set up value N=0, and proceeds to step 306. At step 306, the method compares N with M. If N is not smaller than M, the method proceeds to step 340. At step 304, the method ends. If N is smaller than M, the method proceeds to step 307. At step 307, the method increases N with 1, and proceeds to step 308. At step 308, the method establishes a first bidding period with a first starting time and a first ending time, and proceeds to step 309. At step 309, the method gathers first purchase offers from buyer group N for said product or service by a central control system 101 within said first bidding period, said first purchase offers including one or multiple units of said product or service and excluding price, and proceeds to step 310. At step 310, the method communicating said first purchase offers by said central control system 101 to said seller group N of said product or service within said first bidding period, then receiving bids from said seller group N, said bids including price and meeting all requirements of said various associated terms, said bids being no higher than said ceiling price, each of said seller group N being provided opportunities to modify its own bid repeatedly until said bid being finalized by each of said seller group N to form seller bids N, each of said seller bids N including a bid price and meeting all requirements of said various associated terms, said bid price being no higher than said ceiling price. The method then proceeds to step 311. At step 311, the method forms contract N with seller bids N, and proceeds to step 313. At step 313, the method compares N with 1. If N is not larger than 1, the method proceeds to step 306. If N is larger than 1, the method proceeds to step 314. At step 314, the method compares price N for each identical product in contract N with price 1 for each identical product in contract 1. If price N for one product in contract N is not less than price 1 for same product in contract 1, the process proceeds to step 306. If price N for one product in contract N is less than price 1 for same product in contract 1, the process proceeds to step 315. At step 315, the method set A=1, and proceeds to step 316. At step 316, the method compares A with N. If A is not less than N, the method proceeds to step 306. If A is less than N, the method proceeds to step 317. At step 317, the method sets P_{A}, the price for a specific product in contract A, to P_{N}, the price for the same product in contract N, and proceeds to step 318. At step 318, the method updates contact A with the new prices for each product, and proceeds to step 319. At step 319, the method increases A with 1, and proceed to step 316.

The group bidding method of the second preferred embodiment 300, wherein said N different bidding periods having its own starting time and ending time, all of which being within said transaction period.

The group bidding method of the second preferred embodiment 300, wherein said product or service category can be a plurality of product or service categories, each of which having one product or service.

This second preferred embodiment of current invention of group bidding method 300 can be used in the area of airline ticket purchase. This group bidding method 300 is capable of providing buyer motivation to make purchase offers of various airline tickets and aggregating said purchase offers for airline ticket retailers to compete for such purchase offers. This invention can define a transaction period, such as week, or a month. This invention can further divide such transaction period into different bidding periods, such as a day or a few days. Within each bidding period, the invention can aggregate the demand for certain route, and allow airline ticket retailers to bid for such demand. Upon completion of the bid, the airline ticket retailer with the lowest price would win the purchase demand from buyers. Within the same transaction period, such airline ticket provider might sale the same tickets for the same route for the same time with different prices. If such airline ticket provider is able to sale the same ticket at a lower price later on, the previous buyers will be able to enjoy the lower price offered later. This invention provides incentive for buyers of the tickets to make purchase earlier without afraid of later sales. As the result, airline ticket retailers will be able to realize sale sooner.

This invention can be used for hotel, car insurance, food delivery, shipping, and countless others places.

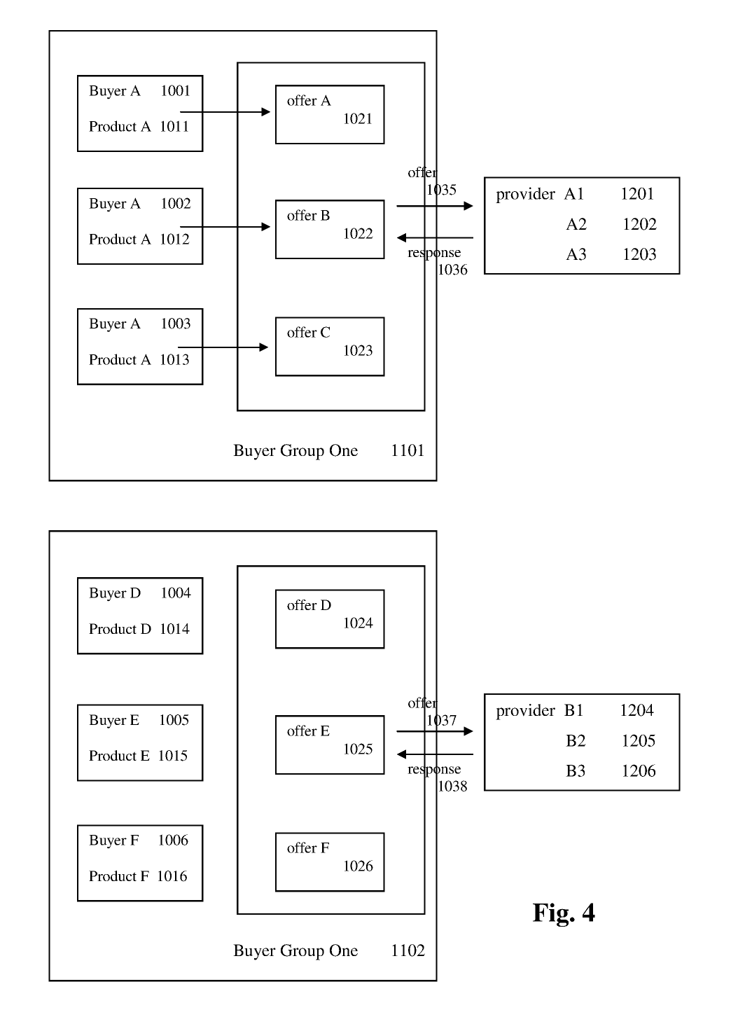

Referring now to FIG. 4, which is an illustration of one application of the first preferred embodiment of current invention. FIG. 4 illustrates an example of 6 buyers, each of whom intends to purchase a different product.

This invention allows this group of six buyers to make a bid to purchase six different products at the same time. Said first set of pre-determined rules allows central control system 101 to arrange and name such six buyers according to the availability of providers. As the result, it is divided into two buyer groups, including Buyer Group One 1101 and Buyer Group Two 1102. All products demanded by Buyer Group One 1101 are able to be supplied by Provider A1 1201, Provider A2 1202, and Provider A3 1203. All products demanded by Buyer Group Two 1102 are able to be supplied by Provider B1 1204, Provide B2 1205, and Provider B3 1206. Said group of six buyers are named Buyer A 1001, Buyer B 1002, Buyer C 1003, Buyer D 1004, Buyer E 1005 and Buyer F 1006. Buyer Group One 1101 includes Buyer A 1001, Buyer B 1002, and Buyer C 1003. Buyer Group B 1102 includes Buyer D 1004, Buyer E 1005 and Buyer F 1006. Buyer A 1001 makes an Offer A 1021 to bid for Product A 1011. Buyer B 1002 makes an Offer B 1022 to bid for Product B 1012. Buyer C 1003 makes an Offer C 1023 to bid for Product C. Buyer D 1004 makes an Offer D 1024 to bid for Product D 1014. Buyer E 1005 makes an Offer E 1025 to bid for Product E 1015. Buyer F 1006 makes an Offer F 1026 to bid for Product F 1016. The central control system 101 will follow pre-determined rules to group Offer A 1021, Offer B 1022, and Offer C 1023, and offer the total amount thereof to Provider A1 1201, Provider A2 1202 and Provider A3 1203, who are the providers capable of providing Product A 1011, Product B 1012, and Product C 1013, however, does not includes the identities of each individual buyer of said Buyer Group One. Said Provider A1 1201, Provider A2 1202, and Provider A3 1203 are provided certain time limit to respond to the central control system 101 regarding said offer 1035. Any of said Provider A1 1201, Provider A2 1202, and Provider A3 1203, who accepts offer 1035 first, will be able to provide the products to Buyer Group One 1101. If the response 1036 from all Provider A2 1202, and Provider A3 1203 is rejection, the central control system 101 will take out one of the offers, and group the rest two offers, and offer the total amount thereof to Provider A1 1201, Provider A2 1202 and Provider A3 1203, however, does not includes the identities of each individual buyer of said Buyer Group One 1101. The central control system 101 takes Offer A 1021 out, and group Offer B 1022 and Offer C 1023, and submit it to Provider A1 1201, Provider A2 1202 and Provider A3 1203. Any of said Provider A1 1201, Provider A2 1202, and Provider A3 1203, who accepts offer 1035 first, will be able to provide the products to Buyer B 1002 and Buyer C 1003. If the response 1036 from all Provider A1, 1201, Provider A2 1202, and Provider A3 1203 is rejection, the central control system 101 then takes Offer B 1022 out, and group Offer A 1021 and Offer C 1023, and submit it to Provider A1 1201, Provider A2 1202 and Provider A3 1203. Any of said Provider A1 1201, Provider A2 1202, and Provider A3 1203, who accepts offer 1035 first, will be able to provide the products to Buyer A 1001 and Buyer C 1003. If the response 1036 from all Provider A1 1201, Provider A2 1202, and Provider A3 1203 is rejection, the central control system 101 then takes Offer C 1023 out, and group Offer A 1021 and Offer B 1022, and submit it to Provider A1 1201, Provider A2 1202 and Provider A3 1203. Any of said Provider A1 1201, Provider A2 1202, and Provider A3 1203, who accepts offer 1035 first, will be able to provide the products to Buyer A 1001 and Buyer B 1002. If the response 1036 from all Provider A1 1201, Provider A2 1202, and Provider A3 1203 is rejection, the central control system 101 then takes any two of Buyer A 1001, Buyer B 1002 and Buyer C 1003 to repeat the process until the offer is accepted, or all the offers are rejected. This process can be repeated for Buyer D 1004, Buyer E 1005 and Buyer F 1006 of Buyer Group Two 1102 as well, until the offer is accepted by either one of Provider B1 1204, Provider B2 1205, and Provider B3 1206, or all the offer combination is rejected.

FIG. 4 illustrates a transaction in one bidding period. Various bidding periods can be categorized into one transaction period. If same provider provides a lower average price for same product at a later bidding period, such price in the earlier bidding period shall be adjusted to reflect the lower average price in a later bidding period. This earlier price for each product in an earlier bidding period can be lowered on a pro rata basis, or average price per unit basis, all of which can be defined by providers in advance of the bidding.

By established buying group, and taking out one offer at each time to make an offer to the provider, and then taking out two offers at each time to make an offer, and until the time all the possibilities are exhausted, this invention effectively helped buyers to have the largest possibility for their offers to be accepted by the providers, at the same time, providers are able to protect their interest in not disclosing providers' bottom-line in their pricing. By adjusting the price in earlier bidding period to those lower price in a later bidding period, this invention provides an incentive for buyers to make their purchase offers sooner rather than later.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

It is to be understood that the invention is not limited in its embodiments disclosed in the preceding description or illustration in the drawings. The invention is capable of other embodiments and of being practiced and carried out in various ways. It is to be understood that the phraseology and terminology employed herein are for the purpose of descriptions and illustrations, and should not b regarded as limitations.

The above description will enable any person skilled in the art to make and use this invention. It also sets forth the best embodiments for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

I claim:

1. A group bidding system capable of providing buyer motivation to make purchase offers of multiple products and services and aggregating said purchase offers of multiple products and services from one buyer or multiple buyers and bidding such purchase offers to one seller or multiple sellers of said multiple products or services, said group bidding system comprising:
a central control system, said central control system capable of receiving and processing said purchase offers of said multiple products and services and communicating sum of said purchase offers and related information to said one seller or said multiple sellers of said multiple products or services;
a buyer interface, said buyer interface being controlled by said central control system, and through which said one buyer or said multiple buyers being able to communicate said purchase offers to said central control system;
a seller interface, said seller interface being controlled by said central control system, and through which said one seller or said multiple sellers being able to receive said sum of said purchase offers and said related information from said central control system, and accept or reject or make counter offer to or make suggestion towards said sum of said purchase offers;
a database, said database being controlled and accessed by said central control system, and having information related to said purchase offers;
a credit verification interface, said credit verification interface being accessed by said central control system, said one buyer or said multiple buyers, and said one seller or said multiple sellers; and
a payment interface, said payment interface being accessed by said central control system, said one buyer or said multiple buyers, and said one seller or said multiple sellers.

2. The group bidding system of claim 1, wherein said central control system is capable of processing said purchase offers of multiple products or services from said one buyer or said multiple buyers within a bidding period according to a first set of pre-determined rules, said first set of pre-determined rules including at least a process to categorize said purchase offers of said multiple products or services into multiple categories, and arrange said purchase offers of said multiple products or services in each of said multiple categories from highest purchase offer to lowest purchase offer, and communicating sum of said purchase offers and number of units in each of said multiple categories to said one seller or said multiple sellers of said multiple products or services.

3. The group bidding system of claim 2, wherein said central control system has an option to disclose said purchase offers of said multiple products or services to said one buyer or said multiple buyers, and allows said one buyer or said multiple buyers with said lowest purchase offer to increase said lowest purchase offer to a higher purchase offer within said bidding period.

4. The group bidding system of claim 3, wherein said central control system is capable of repeating a routine of process of communicating said sum of said purchase offers and number of units in each of said multiple categories to said one seller or said multiple sellers of said multiple products or services according to a second set of pre-determined rules within said bidding period, said second set of pre-determined rules including exclusion of at least one of said multiple products or services with said lowest purchase offer from at least one of said multiple categories before repeating said routine of process of communicating said sum of said purchase offers and number of units in each of said multiple categories to said one seller or said multiple sellers, said one seller or said multiple sellers being able to either accept or reject said sum of said purchase offers and number of units of said multiple categories altogether, until said sum of said purchase offers being accepted by said one seller or said multiple sellers, or all of said purchase offers being excluded from said sum of said purchase offers.

5. The group bidding system of claim 4, wherein said central control system is capable of establishing a transaction period, said transaction period having more than one said bidding period, said one buyer or said multiple buyers whose purchase offers being accepted by said seller or said multiple sellers in a previous bidding period being substituted by purchase offers accepted by said seller or said multiple sellers in a later bidding period, if said purchase offers accepted by said seller or said multiple sellers in said later bidding period being better than said purchase offers accepted by said seller or said multiple sellers in said previous bidding period according to a third set of per-determined rules.

6. The group bidding system of claim 5, wherein said one buyer or said multiple buyers, whose said purchase offers being accepted by said one seller or said multiple sellers, cannot withdraw said purchase offers upon acceptance by said one seller or said multiple sellers.

7. A group bidding system capable of providing buyer motivation to make purchase offers of multiple products and services and aggregating said purchase offers of multiple products and services from one buyer or multiple buyers and communicating such purchase offers to one seller or multiple sellers of said multiple products and services, said group bidding system comprising:
means and computer means for establishing a bidding period;
means and computer means for establishing a transaction period, said transaction period having one or more said bidding periods;
means and computer means for starting said bidding period;
means and computer means for gathering purchase offers from said one buyer or said multiple buyers for said multiple products or services by a central control system;
means and computer means for processing said purchase offers by said central control system according to a first set of pre-determined rules, said first set of pre-determined rules including at least a process to categorize said purchase offers of said multiple products or services into multiple categories, and arrange said purchase offers of said multiple products or services in each of said multiple categories from highest purchase offer to lowest purchase offer;
means and computer means for communicating sum of said purchase offers and number of units in each of said multiple categories by said central control system to said one seller or said multiple sellers of said multiple products or services;
means and computer means for receiving a decision, said decision being either an acceptance or rejection or counter offer or suggestion, by said central control system from said one seller or said multiple sellers; and
means and computer means for communicating said decision by said central control system to said one buyer or said multiple buyers, said one buyer or said multiple buyers, whose purchase offers being accepted by said one seller or said multiple sellers, cannot withdraw said purchase offers upon acceptance by said one seller or said multiple sellers.

8. The group bidding system of claim 7, wherein said central control system comprises
a database, said database being controlled and accessed by said central control system, and having information related to said purchase offers, said one buyer or said multiple buyers, and said one seller or said multiple sellers;
a buyer interface, said buyer interface being controlled by said central control system, and accessed by both said central control system and said one buyer or said multiple buyers;
a seller interface, said seller interface being controlled by said central control system, and accessed by both said central control system and said one seller or said multiple sellers;
a credit verification interface, said credit verification interface being accessed by said central control system, said one buyer or said multiple buyers, and said one seller or said multiple sellers; and
a payment interface, said payment interface being accessed by said central control system, said one buyer or said multiple buyers, and said one seller or said multiple sellers.

9. The group bidding system of claim 7, wherein said central control system is capable of repeating a routine of process of communicating said sum of said purchase offers and number of units in each of said multiple categories to said one seller or said multiple sellers of said multiple products or services according to a second set of pre-determined rules, said second set of pre-determined rules including exclusion of at least one of said multiple products with said lowest purchase offer from at least one of said multiple categories before repeating said routine of process of communicating said sum of said purchase offers and number of units in each of said multiple categories to said one seller or said multiple sellers, until said sum of said purchase offers being accepted by said one seller or said multiple sellers, or all of said purchase offers being excluded from said sum of said purchase offers.

10. The group bidding system of claim 7, wherein each of said multiple sellers of said multiple products or services can provide at least one of said multiple products or services.

11. The group bidding method of claim 7, wherein said central control system is capable of establishing a transaction period, said transaction period having more than one said bidding period, said one buyer or said multiple buyers whose purchase offers being accepted by said seller or said multiple sellers in a previous bidding period being substituted by purchase offers accepted by said seller or said multiple sellers in a later bidding period, if said purchase offers accepted by said seller or said multiple sellers in said later bidding period being better than said purchase offers accepted by said seller or said multiple sellers in said previous bidding period according to a third set of per-determined rules.

12. The group bidding system of claim 7, wherein said central control system has an option to disclose said purchase offers of said multiple products or services to said one buyer or said multiple buyers, and allows said one buyer or said multiple buyers with said lowest purchase offer to increase said lowest purchase offer to a higher purchase offer.

13. A group bidding method capable of providing buyer motivation to make purchase offers of multiple products and services and aggregating said purchase offers of multiple products or services from one buyer or multiple buyers and communicating such purchase offers to one seller or multiple sellers of said multiple products or services, said group bidding method comprising:
establishing a bidding period;
establishing a transaction period, said transaction period having one or more said bidding periods;
starting said bidding period;
gathering purchase offers from said one buyer or said multiple buyers for said multiple products or services by a central control system within said bidding period;
processing said purchase offers by said central control system according to a first set of pre-determined rules, said first set of pre-determined rules including at least a process to categorize said purchase offers of said multiple products or services into multiple categories, and arrange said purchase offers of said multiple products or services in each of said multiple categories from highest purchase offer to lowest purchase offer within said bidding period;
communicating sum of said purchase offers and number of units in each of said multiple categories by said central control system to said one seller or said multiple sellers of said multiple products or services within said bidding period;
receiving a decision, said decision being either an acceptance or rejection or counter offer or suggestion, by said central control system from said one seller or said multiple sellers within said bidding period;
communicating said decision by said central control system to said one buyer or said multiple buyers within said bidding period;
closing said bidding period; and
closing said transaction period upon completion all bidding periods within said transaction period.

14. The group bidding method of claim 13, wherein said central control system comprises
a database, said database being controlled and accessed by said central control system, and having information related to said purchase offers, said one buyer or said multiple buyers, and said one seller or said multiple sellers;
a buyer interface, said buyer interface being controlled by said central control system, and accessed by both said central control system and said one buyer or said multiple buyers;
a seller interface, said seller interface being controlled by said central control system, and accessed by both said central control system and said one seller or said multiple sellers;
a credit verification interface, said credit verification interface being accessed by said central control system, said one buyer or said multiple buyers, and said one seller or said multiple sellers; and
a payment interface, said payment interface being accessed by said central control system, said one buyer or said multiple buyers, and said one seller or said multiple sellers.

15. The group bidding method of claim 13, wherein said central control system is capable of repeating a routine of process of communicating said sum of said purchase offers and number of units in each of said multiple categories to said one seller or said multiple sellers of said multiple products or services according to a second set of pre-determined rules, said second set of pre-determined rules including exclusion of at least one of said multiple products or services with said lowest purchase offer from at least one of said multiple categories before repeating said routine of process of communicating said sum of said purchase offers and number of units in each of said multiple categories to said one seller or said multiple sellers, until said sum of said purchase offers being accepted by said one seller or said multiple sellers, or all of said purchase offers being excluded from said sum of said purchase offers.

16. The group bidding method of claim 13, wherein said central control system is capable of establishing a transaction period, said transaction period having more than one said bidding period, said one buyer or said multiple buyers whose purchase offers being accepted by said seller or said multiple sellers in a previous bidding period shall be substituted by purchase offers accepted by said seller or said multiple sellers in a later bidding period, if said purchase offers accepted by said seller or said multiple sellers in said later bidding period being better than said purchase offers accepted by said seller or said multiple sellers in said previous bidding period according to a third set of per-determined rules.

17. The group bidding method of claim 13, wherein said purchase offers of said multiple products or services from said one buyer or said multiple buyers include different offer prices of said multiple products or services.

18. The group bidding method of claim 13, wherein each of said multiple sellers of said multiple products or services can provide at least one of said multiple products or services.

19. The group bidding method of claim 13, wherein said one buyer or said multiple buyers, whose purchase offers being accepted by said one seller or said multiple sellers, cannot withdraw said purchase offers upon acceptance by said one seller or said multiple sellers.

20. The group bidding method of claim 13, wherein said central control system has an option to disclose said purchase offers of said multiple products or service to said one buyer or said multiple buyers, and allows said one buyer or said multiple buyers with said lowest purchase offer to increase said lowest purchase offer to a higher purchase offer.

21. A group bidding method capable of providing buyer motivation to make purchase offers of multiple products and services and aggregating said purchase offers of multiple products or services from one buyer or multiple buyers and communicating such purchase offers to one seller or multiple sellers of said multiple products or services, said group bidding method comprising:
establishing a transaction period;
starting said transaction period;
establishing a product or service category, said product or service category having a product or service, said product or service having various associated terms, said various associated terms including at least a ceiling price for said product or service;
establishing a first bidding period with a first starting time and a first ending time and a second bidding period with a second starting time and a second ending time, said second ending time being no earlier than said first ending time, said first bidding period and said second bidding period being a part of said transaction period;
starting said first bidding period at said first starting time;
gathering first purchase offers from said one buyer or said multiple buyers for said product or service by a central control system within said first bidding period, said first purchase offers including one or multiple units of said product or service and excluding price;
communicating said first purchase offers by said central control system to said one seller or said multiple sellers of said product or service within said first bidding period;
receiving a first single bid of said first purchase offers by said one seller, said first single bid including a first single bid price and meeting all requirements of said various associated terms, said first single bid price being no higher than said ceiling price, or a group of second bids from some or all of said multiple sellers, each of said multiple sellers being able to provide only one second bid each time, said group of second bids being available to each of said multiple sellers, said multiple sellers being provided opportunities to modify its own said second bid repeatedly until said second bid being finalized by each of said multiple sellers, each of said group of second bids including a second bid price and meeting all requirements of said various associated terms, said second bid price being no higher than said ceiling price;
communicating said first single bid or said second bid by said central control system to said one buyer or said multiple buyers within said first bidding period, said second bid being the best bid defined by said various associated terms, either said first single bid or said second bid being a first bidding period bid;
forming a first contract to fill said first purchase offers within said first bidding period bid by a central control system;
closing said first bidding period at said first ending time;
starting said second bidding period at said second starting time, said second starting time being before, same as or later than said first starting time;
gathering a second purchase offers from said one buyer or said multiple buyers for said product or service by said central control system within said second bidding period, said second purchase offers including one or multiple units of said product or service and excluding price;
communicating said second purchase offers by said central control system to said one seller or said multiple sellers of said product or service within said second bidding period;
receiving a third single bid of said second purchase offers by said one seller, said third single bid including a third single bid price and meeting all requirements of said various associated terms, said third single bid price being no higher than said ceiling price, or a group of fourth bids from some or all of said multiple sellers, each of said multiple sellers being able to provide only one fourth bid each time, said group of fourth bids being available to each of said multiple sellers, said multiple sellers being provided opportunities to modify its own said fourth bid repeatedly until said group of fourth bids being finalized by each of said multiple sellers, each of said group of fourth bids including a fourth bid price and meeting all requirements of said various associated terms, said fourth bid price being no higher than said ceiling price;
communicating said third single bid or said fourth bid by said central control system to said one buyer or said multiple buyers within said second bidding period, said fourth bid being the best bid defined by said various associated terms, either said third single bid or said fourth bid being a second bidding period bid;
forming a second contract to fill said second purchase offers within said second bidding period bid by said central control system;
closing said second bidding period at said second ending time;
replacing said first bidding period bid of said first contract with said second bidding period bid, if said second bidding period bid being better than said first bidding period bid defined by said various associated terms; and
closing said transaction period.

22. The group bidding method of claim 21, wherein said first bidding period bid and said second bidding period bid can cover a part or all of said first purchase offers and said second purchase offers, and be provided by said one seller or some of said multiple sellers jointly.

23. The group bidding method of claim 21, wherein said central control system comprises
a database, said database being controlled and accessed by said central control system, and having information related to said demand and said bid, said one buyer or said multiple buyers, and said one seller or said multiple sellers;
a buyer interface, said buyer interface being controlled by said central control system, and accessed by both said central control system and said one buyer or said multiple buyers;
a seller interface, said seller interface being controlled by said central control system, and accessed by both said central control system and said one seller or said multiple sellers;
a credit verification interface, said credit verification interface being accessed by said central control system, said one buyer or said multiple buyers, and said one seller or said multiple sellers; and
a payment interface, said payment interface being accessed by said central control system, said one buyer or said multiple buyers, and said one seller or said multiple sellers.

24. The group bidding method of claim 21, wherein said second bidding period can be a plurality of bidding periods with its own starting time and ending time, all of which being within said transaction period and having all features of said second bidding period.

25. The group bidding method of claim 21, wherein said product or service category can be a plurality of product or service categories, each of which having one product or service.

26. The group bidding method of claim 21, wherein said one buyer or said multiple buyers cannot withdraw said first purchase offers upon forming said first contract, or said second purchase offers upon forming said second contract.

27. A group bidding system capable of providing buyer motivation to make purchase offers of multiple products and services and aggregating said purchase offers of multiple products or services from one buyer or multiple buyers and communicating such purchase offers to one seller or multiple sellers of said multiple products or services, said group bidding system comprising:
means and computer means for establishing a transaction period;
means and computer means for starting said transaction period;
means and computer means for establishing a product or service category, said product or service category having a product or service, said product or service having various associated terms, said various associated terms including at least a ceiling price for said product or service;
means and computer means for establishing a first bidding period with a first starting time and a first ending time and a second bidding period with a second starting time and a second ending time, said second ending time being no earlier than said first ending time, said first bidding period and said second bidding period being a part of said transaction period;
means and computer means for starting said first bidding period at said first starting time;
means and computer means for gathering first purchase offers from said one buyer or said multiple buyers for said product or service by a central control system within said first bidding period, said first purchase offers including one or multiple units of said product or service and excluding price;
means and computer means for communicating said first purchase offers by said central control system to said one seller or said multiple sellers of said product or service within said first bidding period;
means and computer means for receiving a first single bid of said first purchase offers by said one seller, said first single bid including a first single bid price and meeting all requirements of said various associated terms, said first single bid price being no higher than said ceiling price, or a group of second bids from some or all of said multiple sellers, each of said multiple sellers being able to provide only one second bid each time, said group of second bids being available to each of said multiple sellers, said multiple sellers being provided opportunities to modify its own said second bid repeatedly until said second bid being finalized by each of said multiple sellers, each of said group of second bids including a second bid price and meeting all requirements of said various associated terms, said second bid price being no higher than said ceiling price;
means and computer means for communicating said first single bid or said second bid by said central control system to said one buyer or said multiple buyers within said first bidding period, said second bid being the best bid defined by said various associated terms, either said first single bid or said second bid being a first bidding period bid;
means and computer means for forming a first contract to fill said first purchase offers within said first bidding period bid by a central control system;
means and computer means for closing said first bidding period at said first ending time;
means and computer means for starting said second bidding period at said second starting time, said second starting time being before, same as or later than said first starting time;
means and computer means for gathering a second purchase offers from said one buyer or said multiple buyers for said product or service by said central control system within said second bidding period, said second purchase offers including one or multiple units of said product or service and excluding price;
means and computer means for communicating said second purchase offers by said central control system to said one seller or said multiple sellers of said product or service within said second bidding period;
means and computer means for receiving a third single bid of said second purchase offers by said one seller, said third single bid including a third single bid price and meeting all requirements of said various associated terms, said third single bid price being no higher than said ceiling price, or a group of fourth bids from some or all of said multiple sellers, each of said multiple sellers being able to provide only one fourth bid each time, said group of fourth bids being available to each of said multiple sellers, said multiple sellers being provided opportunities to modify its own said fourth bid repeatedly until said group of fourth bids being finalized by each of said multiple sellers, each of said group of fourth bids including a fourth bid price and meeting all requirements of said various associated terms, said fourth bid price being no higher than said ceiling price;
means and computer means for communicating said third single bid or said fourth bid by said central control system to said one buyer or said multiple buyers within said second bidding period, said fourth bid being the best bid defined by said various associated terms, either said third single bid or said fourth bid being a second bidding period bid;
means and computer means for forming a second contract to fill said second purchase offers within said second bidding period bid by said central control system;
means and computer means for closing said second bidding period at said second ending time;
means and computer means for replacing said first bidding period bid of said first contract with said second bidding period bid, if said second bidding period bid being better than said first bidding period bid defined by said various associated terms; and
means and computer means for closing said transaction period.

28. The group bidding system of claim 27, wherein said first bidding period bid and said second bidding period bid can cover a part or all of said first purchase offers and said second purchase offers, and be provided by said one seller or some of said multiple sellers jointly.

29. The group bidding method of claim 27, wherein said central control system comprises
a database, said database being controlled and accessed by said central control system, and having information related to said demand and said bid, said one buyer or said multiple buyers, and said one seller or said multiple sellers;
a buyer interface, said buyer interface being controlled by said central control system, and accessed by both said central control system and said one buyer or said multiple buyers;
a seller interface, said seller interface being controlled by said central control system, and accessed by both said central control system and said one seller or said multiple sellers;
a credit verification interface, said credit verification interface being accessed by said central control system, said one buyer or said multiple buyers, and said one seller or said multiple sellers; and
a payment interface, said payment interface being accessed by said central control system, said one buyer or said multiple buyers, and said one seller or said multiple sellers.

30. The group bidding method of claim 27, wherein said second bidding period can be a plurality of bidding periods with its own starting time and ending time, all of which being within said transaction period and having all features of said second bidding period.

31. The group bidding method of claim 27, wherein said product or service category can be a plurality of product or service categories, each of which having one product or service.

32. The group bidding method of claim 27, wherein said one buyer or said multiple buyers cannot withdraw said first purchase offers upon forming said first contract, or said second purchase offers upon forming said second contract.

33. A group bidding method capable of providing buyer motivation to make purchase offers of multiple products and services and aggregating said purchase offers of multiple products or services from multiple buyers and communicating such purchase offers to multiple sellers of said multiple products or services, said group bidding method comprising:
establishing a transaction period;
starting said transaction period;
establishing a list of products or services, each of said list of products or services having various associated terms, said various associated terms including at least a ceiling price for said product or service and a delivery term;
establishing a first bidding period with a first starting time and a first ending time, a second bidding period with a second starting time and a second ending time, and a third bidding period with a third starting time and a third ending time, said second ending time being no earlier than said first ending time, said third ending time being no earlier than said second ending time, said first bidding period, said second bidding period and said third bidding period being a part of said transaction period;
starting said first bidding period at said first starting time;
gathering first purchase offers from one or more of said multiple buyers for each of said list of products or services by a central control system within said first bidding period, said first purchase offers including a first purchase number of units associated with each of said list of products or services and excluding price;
communicating said first purchase offers by said central control system to each of said multiple sellers of said list of products or services within said first bidding period, each of said multiple sellers being able to provide at least one of said list of products or services;
receiving a group of first bids from some or all of said multiple sellers for some or all of said first purchase offers, each of said multiple sellers being able to provide only one first bid each time for some or all of each of said list of products or services, said group of first bids being available to each of said multiple sellers, said multiple sellers being provided opportunities to modify its own said first bid for some or all of each of said list of products or services repeatedly until said first bid being finalized by each of said multiple sellers, each of said group of first bids including a first bid price and for a first bid number of units associated with said first bid price and meeting all requirements of said various associated terms, said first bid price being no higher than said ceiling price, said first bid number being no more than said first purchase number;
communicating a group of first bidding period bids by said central control system to said multiple buyers within said first bidding period, said group of first bidding period bids including the best bid from said group of first bids defined by said various associated terms for each of said list of products or services;
forming a first contract to fill said first purchase offers by said group of first bidding period bids, said one buyer or said multiple buyers cannot withdraw said first purchase offers upon forming said first contract for said group of first bidding period bids;
closing said first bidding period at said first ending time;
starting said second bidding period at said second starting time, said second starting time being before, same as or later than said first starting time;
gathering second purchase offers from one or more of said multiple buyers for each of said list of products or services by said central control system within said second bidding period, said second purchase offers including a second purchase number of units associated with each of said list of products or services and excluding price;
communicating said second purchase offers by said central control system to each of said multiple sellers of said list of products or services within said second bidding period, each of said multiple sellers being able to provide at least one of said list of products or services;
receiving a group of second bids from some or all of said multiple sellers for some or all of said second purchase offers, each of said multiple sellers being able to provide only one second bid each time for some or all of each of said list of products or services, said group of second bids being available to each of said multiple sellers, said multiple sellers being provided opportunities to modify its own said second bid for some or all of each of said list of products or services repeatedly until said second bid being finalized by each of said multiple sellers, each of said group of second bids including a second bid price and for a second bid number of units associated with said second bid price and meeting all requirements of said various associated terms, said second bid price being no higher than said ceiling price, said second bid number being no more than said second purchase number;
communicating a group of second bidding period bids by said central control system to said multiple buyers within said second bidding period, said group of second bidding period bids including the best bid from said group of second bids defined by said various associated terms for each of said list of products or services;
forming a second contract to fill said second purchase offers by said group of second bidding period bids, said one buyer or said multiple buyers cannot withdraw said second purchase offers upon forming said second contract for said group of second bidding period bids;
closing said second bidding period at said second ending time;
replacing said first bid in said first bidding period bids of said first contract with said second bid in said second bidding period bids, if both said first bid and said second bid being for same product or service, and said second bid being better than said first bid defined by said various associated terms;
starting said third bidding period at said third starting time, said third starting time being before, same as or later than said second starting time;
gathering third purchase offers from one or more of said multiple buyers for each of said list of products or services by said central control system within said third bidding period, said third purchase offers including a third purchase number of units associated with for each of said list of products or services and excluding price;
communicating said third purchase offers by said central control system to each of said multiple sellers of said list of products or services within said third bidding period, each of said multiple sellers being able to provide at least one of said list of products or services;
receiving a group of third bids from some or all of said multiple sellers for some or all of said third purchase offers, each of said multiple sellers being able to provide only one third bid each time for some or all of each of said list of products or services, said group of third bids being available to each of said multiple sellers, said multiple sellers being provided opportunities to modify its own said third bid for some or all of each of said list of products or services repeatedly until said third bid being finalized by each of said multiple sellers, each of said group of third bids including a third bid price and for a third bid number of units associated with said third bid price and meeting all requirements of said various associated terms, said third bid price being no higher than said ceiling price, said third bid number being no more than said third purchase number;
communicating a group of third bidding period bids by said central control system to said multiple buyers within said third bidding period, said group of third bidding period bids including the best bid from said group of third bids defined by said various associated terms for each of said list of products or services;
forming a third contract to fill said third purchase offers by said group of third bidding period bids, said one buyer or said multiple buyers cannot withdraw said third purchase offers upon forming said third contract for said group of third bidding period bids;
closing said third bidding period at said third ending time;
replacing said first bid in said first bidding period bids of said first contract with said third bid in said third bidding period bids, if all said first bid, said second bid and said third bid being for same product or service, and said third bid being better than said first bid and said second bid defined by said various associated terms;
replacing said second bid in said second bidding period bids of said second contract with said third bid in said third bidding period bids, if both said second bid and said third bid being for same product or service, and said third bid being better than said second bid defined by said various associated terms; and
closing said transaction period.

34. The group bidding method of claim 33, wherein said group of first bidding period bids, said group of second bidding period bids, and said group of third bidding period bids can cover a part or all of said first purchase offers, said second purchase offers, and said third purchase offers, and be provided by one or some of said multiple sellers jointly.

35. The group bidding method of claim 33, wherein said third bidding period can be a plurality of bidding periods with its own starting time and ending time, all of which being within said transaction period and having all features of said third bidding period.

36. A group bidding system capable of providing buyer motivation to make purchase offers of multiple products and services and aggregating said purchase offers of multiple products or services from multiple buyers and communicating such purchase offers to multiple sellers of said multiple products or services, said group bidding system comprising:
means and computer means for establishing a transaction period;
means and computer means for starting said transaction period;
means and computer means for establishing a list of products or services, each of said list of products or services having various associated terms, said various associated terms including at least a ceiling price for said product or service and a delivery term;
means and computer means for establishing a first bidding period with a first starting time and a first ending time, a second bidding period with a second starting time and a second ending time, and a third bidding period with a third starting time and a third ending time, said second ending time being no earlier than said first ending time, said third ending time being no earlier than said second ending time, said first bidding period, said second bidding period and said third bidding period being a part of said transaction period;
means and computer means for starting said first bidding period at said first starting time;
means and computer means for gathering first purchase offers from one or more of said multiple buyers for each of said list of products or services by a central control system within said first bidding period, said first purchase offers including a first purchase number of units associated with each of said list of products or services and excluding price;
means and computer means for communicating said first purchase offers by said central control system to each of said multiple sellers of said list of products or services within said first bidding period, each of said multiple sellers being able to provide at least one of said list of products or services;
means and computer means for receiving a group of first bids from some or all of said multiple sellers for some or all of said first purchase offers, each of said multiple sellers being able to provide only one first bid each time for some or all of each of said list of products or services, said group of first bids being available to each of said multiple sellers, said multiple sellers being provided opportunities to modify its own said first bid for some or all of each of said list of products or services repeatedly until said first bid being finalized by each of said multiple sellers, each of said group of first bids including a first bid price and for a first bid number of units associated with said first bid price and meeting all requirements of said various associated terms, said first bid price being no higher than said ceiling price, said first bid number being no more than said first purchase number;
means and computer means for communicating a group of first bidding period bids by said central control system to said multiple buyers within said first bidding period, said group of first bidding period bids including the best bid from said group of first bids defined by said various associated terms for each of said list of products or services;
means and computer means for forming a first contract to fill said first purchase offers by said group of first bidding period bids, said one buyer or said multiple buyers cannot withdraw said first purchase offers upon forming said first contract for said group of first bidding period bids;
means and computer means for closing said first bidding period at said first ending time;
means and computer means for starting said second bidding period at said second starting time, said second starting time being before, same as or later than said first starting time;
means and computer means for gathering second purchase offers from one or more of said multiple buyers for each of said list of products or services by said central control system within said second bidding period, said second purchase offers including a second purchase number of units associated with each of said list of products or services and excluding price;
means and computer means for communicating said second purchase offers by said central control system to each of said multiple sellers of said list of products or services within said second bidding period, each of said multiple sellers being able to provide at least one of said list of products or services;
means and computer means for receiving a group of second bids from some or all of said multiple sellers for some or all of said second purchase offers, each of said multiple sellers being able to provide only one second bid each time for some or all of each of said list of products or services, said group of second bids being available to each of said multiple sellers, said multiple sellers being provided opportunities to modify its own said second bid for some or all of each of said list of products or services repeatedly until said second bid being finalized by each of said multiple sellers, each of said group of second bids including a second bid price and for a second bid number of units associated with said second bid price and meeting all requirements of said various associated terms, said second bid price being no higher than said ceiling price, said second bid number being no more than said second purchase number;
means and computer means for communicating a group of second bidding period bids by said central control system to said multiple buyers within said second bidding period, said group of second bidding period bids including the best bid from said group of second bids defined by said various associated terms for each of said list of products or services;
means and computer means for forming a second contract to fill said second purchase offers by said group of second bidding period bids, said one buyer or said multiple buyers cannot withdraw said second purchase offers upon forming said second contract for said group of second bidding period bids;
means and computer means for closing said second bidding period at said second ending time;
means and computer means for replacing said first bid in said first bidding period bids of said first contract with said second bid in said second bidding period bids, if both said first bid and said second bid being for same product or service, and said second bid being better than said first bid defined by said various associated terms;
means and computer means for starting said third bidding period at said third starting time, said third starting time being before, same as or later than said second starting time;
means and computer means for gathering third purchase offers from one or more of said multiple buyers for each of said list of products or services by said central control system within said third bidding period, said third purchase offers including a third purchase number of units associated with for each of said list of products or services and excluding price;
means and computer means for communicating said third purchase offers by said central control system to each of said multiple sellers of said list of products or services within said third bidding period, each of said multiple sellers being able to provide at least one of said list of products or services;
means and computer means for receiving a group of third bids from some or all of said multiple sellers for some or all of said third purchase offers, each of said multiple sellers being able to provide only one third bid each time for some or all of each of said list of products or services, said group of third bids being available to each of said multiple sellers, said multiple sellers being provided opportunities to modify its own said third bid for some or all of each of said list of products or services repeatedly until said third bid being finalized by each of said multiple sellers, each of said group of third bids including a third bid price and for a third bid number of units associated with said third bid price and meeting all requirements of said various associated terms, said third bid price being no higher than said ceiling price, said third bid number being no more than said third purchase number;
means and computer means for communicating a group of third bidding period bids by said central control system to said multiple buyers within said third bidding period, said group of third bidding period bids including the best bid from said group of third bids defined by said various associated terms for each of said list of products or services;
means and computer means for forming a third contract to fill said third purchase offers by said group of third bidding period bids, said one buyer or said multiple buyers cannot withdraw said third purchase offers upon forming said third contract for said group of third bidding period bids;
means and computer means for closing said third bidding period at said third ending time;
means and computer means for replacing said first bid in said first bidding period bids of said first contract with said third bid in said third bidding period bids, if all said first bid, said second bid and said third bid being for same product or service, and said third bid being better than said first bid and said second bid defined by said various associated terms;
means and computer means for replacing said second bid in said second bidding period bids of said second contract with said third bid in said third bidding period bids, if both said second bid and said third bid being for same product or service, and said third bid being better than said second bid defined by said various associated terms; and
means and computer means for closing said transaction period.

37. The group bidding system of claim 36, wherein said group of first bidding period bids, said group of second bidding period bids, and said group of third bidding period bids can cover a part or all of said first purchase offers, said second purchase offers, and said third purchase offers, and be provided by one or some of said multiple sellers jointly.

38. The group bidding system of claim 36, wherein said third bidding period can be a plurality of bidding periods with its own starting time and ending time, all of which being within said transaction period and having all features of said third bidding period.
